(19) United States
(12) Patent Application Publication
(10) Pub. No.: US 2014/0188651 A1
(43) Pub. Date: Jul. 3, 2014

(54) DOMAIN NAME REGISTRATION AND RESALE

(71) Applicant: Minds + Machines, Santa Monica, CA (US)

(72) Inventor: Frederick R Krueger, Santa Monica, CA (US)

(21) Appl. No.: 13/733,058

(22) Filed: Jan. 2, 2013

(51) Int. Cl. G06Q 30/06

(52) U.S. Cl. CPC G06Q 30/0641
USPC 705/26.3; 705/27.1

(57) ABSTRACT

A method and system for providing domain name registration and resale at the registry level and a corresponding apparatus. The apparatus is a Database Management Platform held and operated at the registry level but incorporated into each registrar-level transaction. The Database Management Platform includes the database, the logic for querying the database, and a system built around the database; it stores information in a structured format to be accessible for queries. The registrar receives a request from an end-user for a domain name; the registrar accesses the registry, which queries the Database Management Platform to determine whether the domain name is available and, if not, if it is for sale. The registrar provides this information to the end-user. If the end-user chooses to, the apparatus operates the sale/purchase transaction between current owner and the end-user. If sufficient funds exist, the end-user's account is debited and the current owner's account is credited. The domain name is transferred. Methods and systems for completing these transactions are also provided.

### TECHNICAL FIELD

The described systems relate generally to the registration and resale of domain names in an Internet domain name system.

### SUMMARY OF THE INVENTION WITH BACKGROUND INFORMATION

Internet registries operate in the primary market for domain names and not in the secondary market. A registry has no record of whether a domain name is available for resale and, if so, at what price, so the secondary market for domain names is constrained by not having a central repository for this information. A system for keeping information relating to the secondary market of domain names at the registry level, accessible by all registrars as well as by users, has eluded those skilled in the art, until now.

The invention relates generally to a repository for information about domain names for sale. Briefly stated, embodiments of the invention provide a method and system for domain name registration and resale at the registry level. The system includes a Database Management Platform (“DMP”) held and operated at the registry level but available at each registrar-level transaction. The DMP includes a database, logic for querying the database, and a system built around the database. The DMP stores information in a structured format to be accessible for queries.

In one method, a registrar receives a request from an end-user for a domain name. The registrar accesses the registry, which queries the DMP to determine whether the domain name is available and, if not, if it is for sale. The registrar provides this information to the end-user. If the end-user chooses to, the DMP facilitates the sale/purchase transaction between the current owner and the end-user. If sufficient funds exist, the end-user's account is debited and the current owner's account is credited. The domain name is thereby transferred.

### BRIEF DESCRIPTION OF THE DRAWINGS

FIG. 1 is a process diagram generally illustrating steps performed by the disclosed registry, Database Management Platform, and resale system.

FIG. 2 is a process diagram generally illustrating additional steps performed by the disclosed registry, Database Management Platform, and resale system.

FIG. 3 is a process diagram generally illustrating still additional steps performed by the disclosed registry, Database Management Platform, and resale system.

FIG. 4 is a process diagram generally illustrating still more steps performed by the disclosed registry, Database Management Platform, and resale system.

FIG. 5 is a process diagram generally illustrating still more steps performed by the disclosed registry, Database Management Platform, and resale system.

FIG. 6 is a process diagram generally illustrating steps performed by the disclosed registry, Database Management Platform, and resale system to purchase a domain name.

FIG. 7 is a process diagram generally illustrating additional steps performed by the disclosed registry, Database Management Platform, and resale system to purchase a domain name.

FIG. 8 is a process diagram generally illustrating still additional steps performed by the disclosed registry, Database Management Platform, and resale system to purchase a domain name.

FIG. 9 is a functional block diagram illustrating a computing device that may be used to implement embodiments of the invention.

### DETAILED DESCRIPTION

Generally stated, disclosed is a system for registering domain names and listing them for resale, either at the time of or after registration. The system uses a connection between a registrant and registrar over the Internet or another computer network. The mechanisms for conducting such a transaction session may include using an Extensible Provisioning Protocol (EPP), other Application Programming Interfaces (APIs) commonly used in the registry operations industry, as well as other means of communication and transport protocols. Those skilled in the art will recognize the means for conducting such a session, including means generally available, conceivable, or yet to be developed. The system also stores a result of the transaction sessions in a digital database.

In the disclosed embodiments, a registry stores different state types for individual domain names that are either registered in the Top Level Domain (“TLD”) registry or specially identified strings that await registration in the registry database apparatus. These include registered and not for sale, registered and for sale at a stated price, registered and for sale: make an offer, unregistered and available at the base price, unregistered and reserved (trademarked), and unregistered and available at a greater-than-base price (premium names).

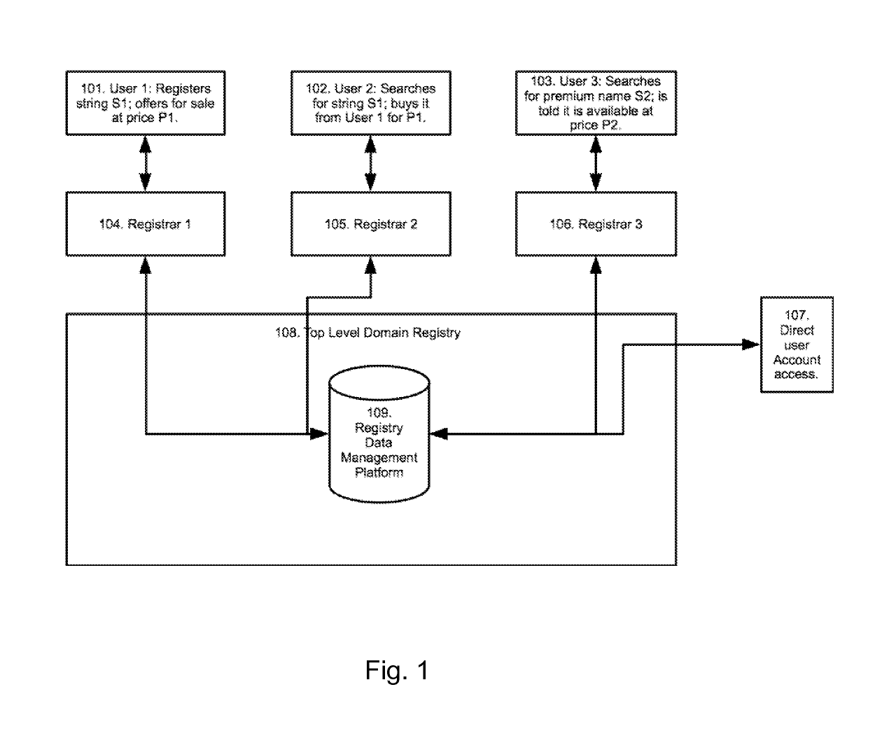

FIG. 1 is a conceptual process diagram of the disclosed registry, Database Management Platform, and resale system generally showing a hypothetical user selling string S1 at price P1 where the buyer and seller are using two separate registrars. A third user is querying the system for a premium name held back by the top-level domain registry database.

As illustrated in FIG. 1, a user 101 registers a string (S1), such as a domain name (e.g., example.com). The user 101 chooses to offer the string S1 for sale at a price (P1). By conveying these choices to a registrar 104, the registrar 104 accesses a Top Level Domain (TLD) registry 108 to register the string (S1) for the user 101. In addition, the registrar 104 annotates a Database Management Platform (DMP) 109 to indicate that the string (S1) is available for sale at price (P1).

If a second user 102, interacts with a second registrar 105 and attempts to register the string (S1), the second user 102 will be informed by the second registrar 105 that the string (S1) is already registered. However, because the second registrar 105 accessed the TLD registry 108, the second registrar 105 learned that the string (S1) was available for sale at price P1. The second user 102 thereby is offered to acquire the string (S1) at price P1. In this manner, the second user 102 is able to acquire the string (S1) even though the second user 102 does not interact directly with the first registrar 104 and without the need to investigate alternative systems, registries, or data stores for information about the availability of the string (S1).

In addition, a third user 103 may attempt to register another string (S2), which, in this example, constitutes a premium name. In this embodiment, a premium name commands a different, generally higher, price P2. Accordingly, a third registrar 106 notifies the third user 103 that the second string (S2) is available for acquisition at price P2. It should be understood that it is not necessary that three separate registrars be used, only that the described transactions may occur even if two or three separate registrars are used.

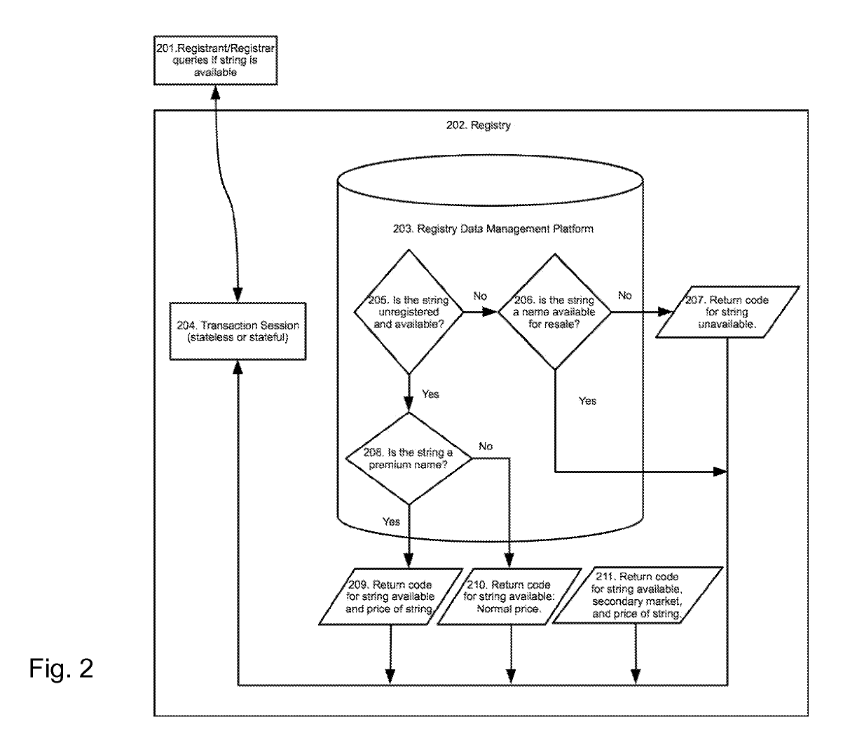

FIG. 2 is a conceptual process diagram of a registry, Database Management Platform (DMP), and resale system handling a request to register a string. As shown in FIG. 2, an inquiry is made (201) to determine if a string is available and, if so, at what price. The DMP handles the inquiry by determining if the string is unregistered and available (205). If so, the DMP determines if the string is a premium name (208). If not, then a return code is provided indicating that the string is available at a normal price (210). If so, then a return code is provided indicating that the strings is available at a premium price (209).

If the string has already been registered, the DMP determines if the string is available for resale (206). If not, the requesting registrar is notified that the string is unavailable. If so, the DMP notifies the registrar that the string is available to acquire at an appropriate price (211).

In summary, the registry 202 determines the appropriate state of the string (name): whether the name is unavailable or reserved; whether the name is a premium name; whether the name is an ordinary, freely registrable name; or whether the name has been previously registered and is available for resale.

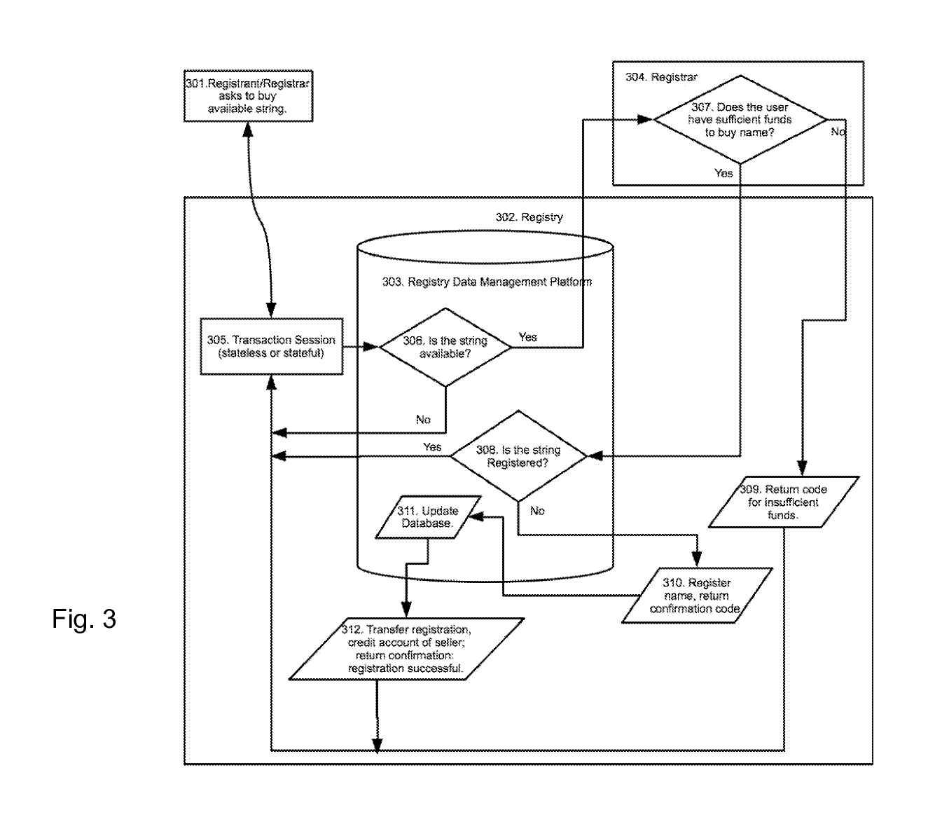

FIG. 3 is a conceptual process diagram of a registry, Database Management Platform (DMP), and resale system handling a request to acquire a string that has been identified as for sale. As shown in FIG. 3, if it has been determined that the string is available for sale by a current owner (306), a determination is made whether the requesting user has sufficient funds to purchase the name (304). If not, the user is informed that funds are insufficient to perform the transaction (309). If so, the user is informed that the name is available at the stated price.

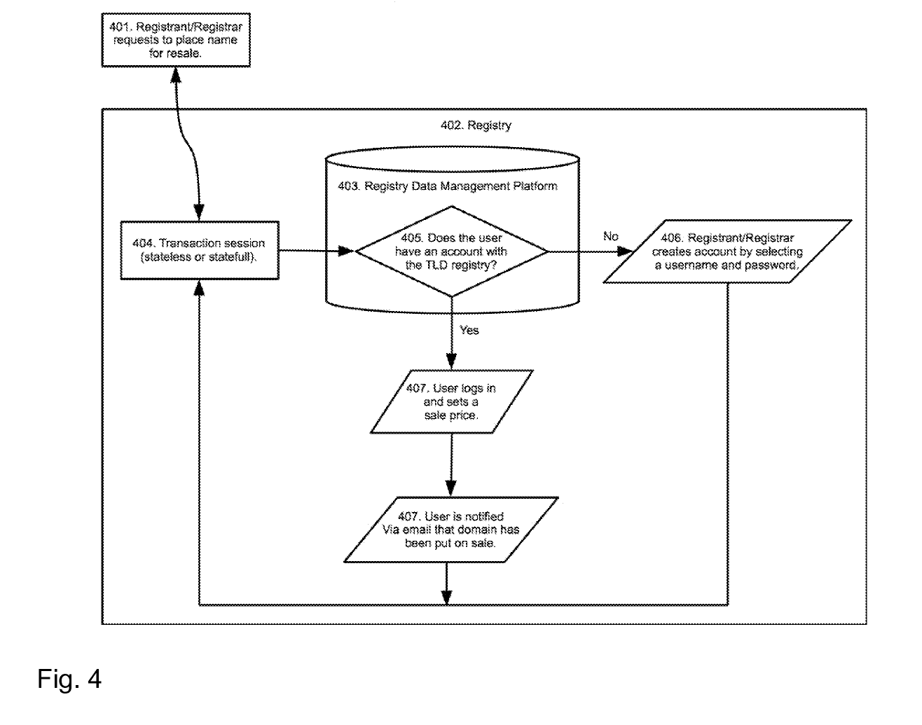

FIG. 4 is a conceptual process diagram of the disclosed registry, Database Management Platform (DMP), and resale system handling a request to place a name up for sale. As shown in FIG. 4, the current owner of the name indicates that the name is for sale and identifies a sale price (407). If the current owner does not have an account for facilitating sales transactions, the current owner is prompted to create one (406). Note that the price of the name is saved on the registry database.

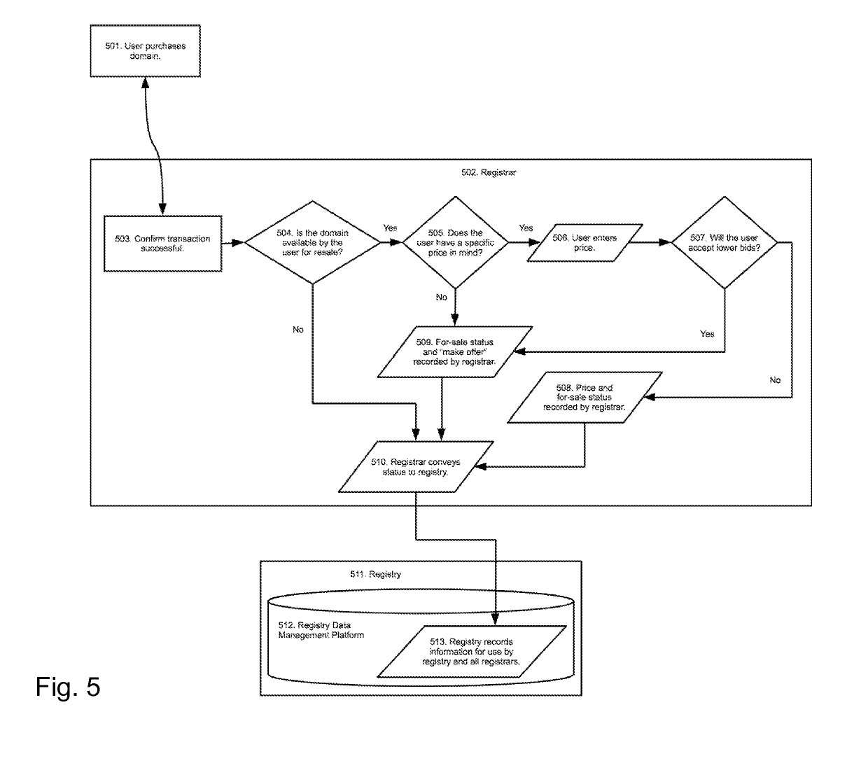

FIG. 5 is a conceptual process diagram of the disclosed registry, Database Management Platform (DMP), and resale system handling a request to purchase a name that is for sale. If the name is available for sale (504), the user may make an offer to purchase the name at the user's desired price (506). Such an offer may take the form of an auction bid. Alternatively, a simple indication that the user is interested in purchasing the name without giving a specific price may be made (509). The user's registrar conveys the offer to the DMP at the TLD registry (511).

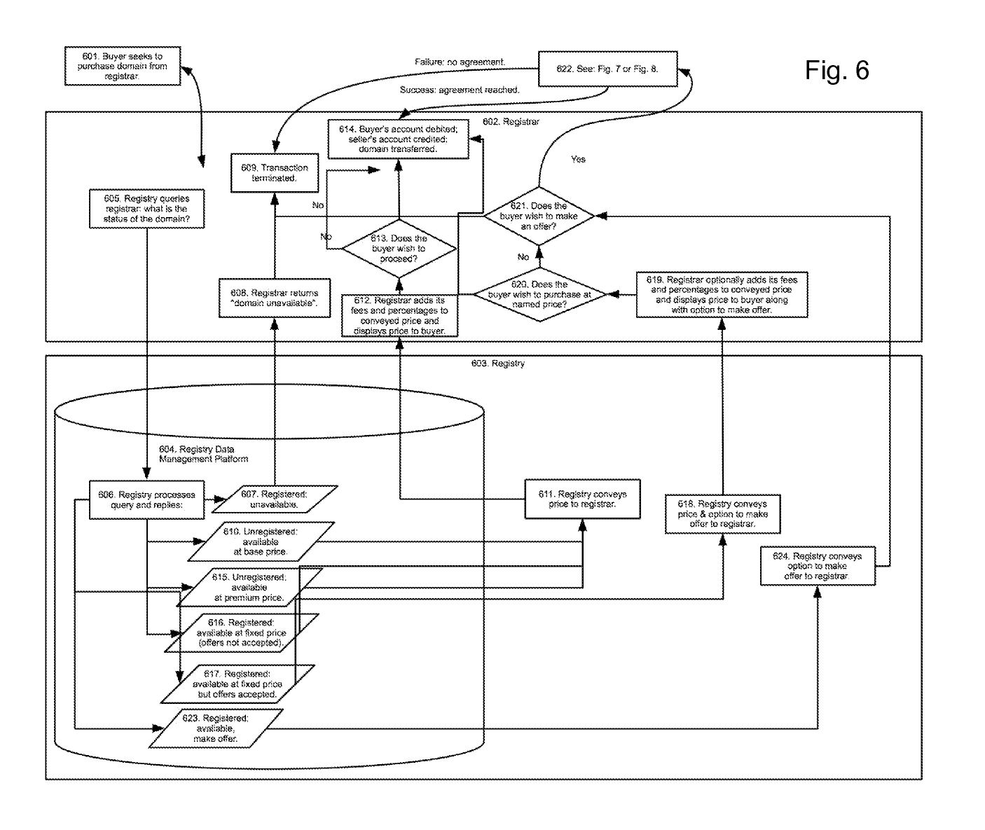

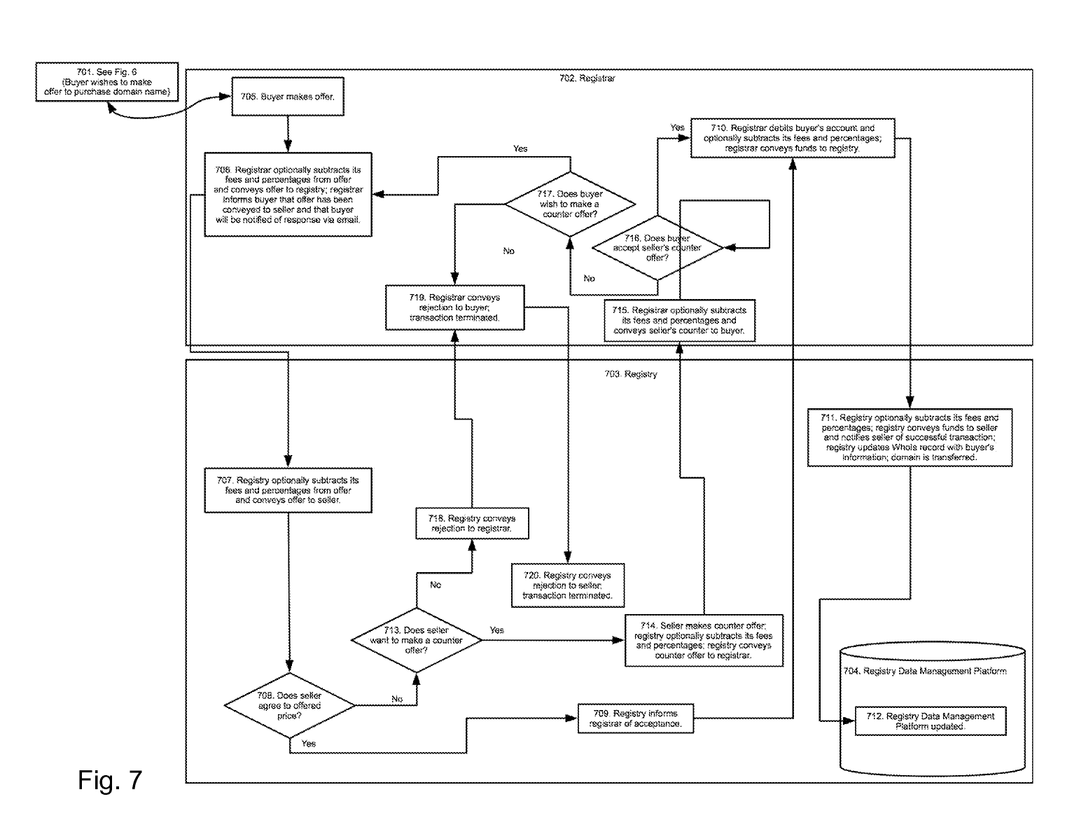

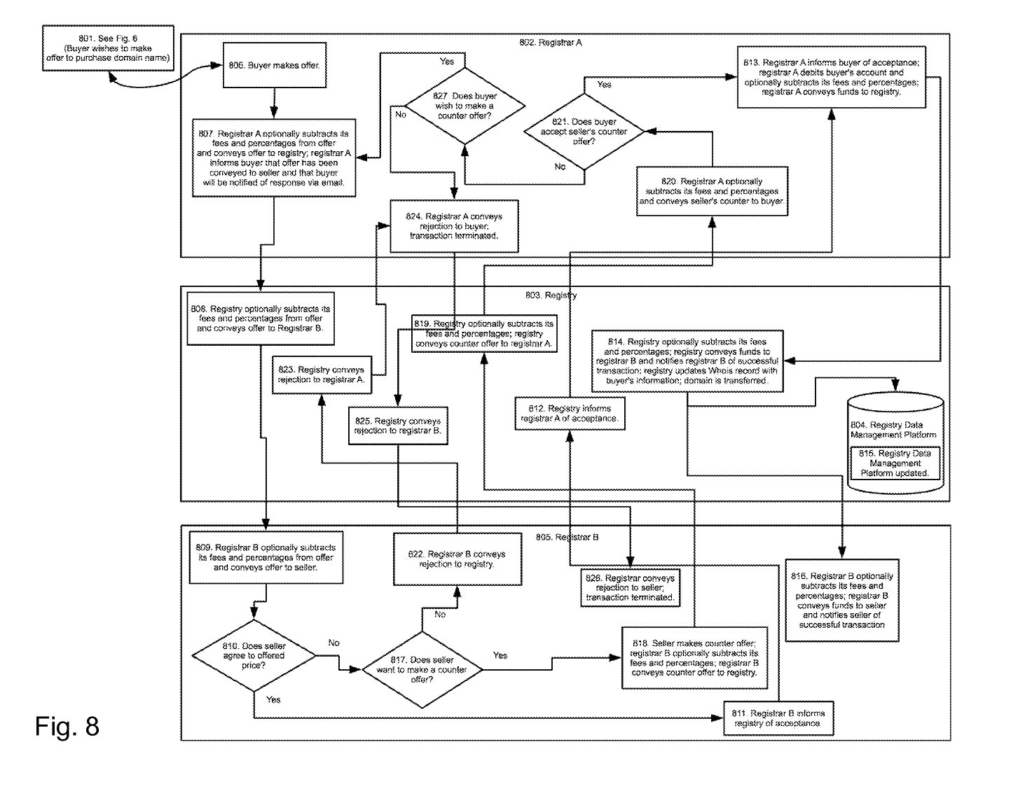

FIGS. 6-8 together constitute a conceptual process diagram of the disclosed registry, Database Management Platform, and resale system depicting the generic process of purchasing a domain that has been listed as for sale. As shown in FIG. 6, if the name is simply unavailable for registration, that information is conveyed to the requesting registrar (608). However, if the name is available for sale, a price is determined. For instance, the name may be available at a base price (610), a premium price (615), or some other fixed price (616). If so, the appropriate price is conveyed to the registrar (612), which may add additional fees. The buyer may be prompted to make an offer to purchase the name (621). If the buyer desires to proceed, the process continues as illustrated in FIGS. 7-8.

If the seller has an account at the registry level (TLD), the registry and the buyer's registrar may transact directly to facilitate the transfer of the name as shown in FIG. 7. As illustrated, a buyer makes an offer to acquire the name (705). The buyer's and seller's registrars may iterate through bids and offers in an attempt to conclude the transaction. Once an offer (less any transaction fees) is sufficient to conclude the transaction, the buyer's registrar transfers funds for the transaction (710) and the seller's registrar implements the steps to transfer the name from the seller to the buyer (711).

If the seller only has a registrar-level account, then the buyer's registrar and seller's registrar may transact among themselves or via the TLD registry as shown in FIG. 8. The process may be the same whether the seller and the buyer have accounts at the same registrar or at different registrars. As illustrated in FIG. 8, the process is similar to the case where the seller has a registry-level account in that the buyer and seller may exchange offers or counteroffers, and acceptances or rejections. However, in this embodiment, the offers, counteroffers, and responses (acceptances or rejections) are transmitted using the registry 808 as an intermediary.

Certain features of the invention will be apparent to those skilled in the art from the foregoing teachings. For instance, in a first enclosed embodiment, a registry database stores names that are either reserved (ineligible for registration), registered and not for sale (also ineligible for registration), names that are registered but also for sale, or names that are unregistered. In the third case, the database contains not only the strings themselves, but also the price at which these strings are available (if stated) and a user ID corresponding to the user(s) who registered the strings.

In the first disclosed embodiment, if a user selects a name that has been previously registered and placed for sale, the registry communicates the sale price to the registrar, who can then mark the price up if desired and display it to the user as a “premium name”. If the purchaser decides to proceed with the transaction, the registry transfers the registered name to the buyer and corrects the Whois information to reflect the new buyer's contact information. The price of the domain is debited by the registrar from the buyer's account with the registrar and transferred, less any registrar fees, to the registry. The registry then transfers the money to the seller's registry account, less any registry fees. This triggers an email to the seller from the registry to the seller, notifying the seller that the domain name has been sold and the seller's account has been credited.

In this embodiment, the seller has previously set up an account with a username and password on the registry. The seller may also use a registrar account; in this embodiment, the registry will transfer the money to the seller's registrar account, less any registry fees. The seller's registrar will send an email to the seller notifying the seller that the domain name has been sold and the seller's account has been credited.

Practitioners skilled in the art will appreciate that registration services relating to the secondary sale of a domain name is very similar, from a registrant perspective, to registration services for premium domains currently in place. Unlike such systems however, the seller of the name has no need to independently list the name on a secondary domain marketplace due to the registry database accessible by all registrars and by end-users.

In the first disclosed embodiment, the registry implements a number of API protocols that enable registrars to update the sale price recorded in the registry database of any name for any user who has granted the registrar this permission, including the ability to cancel the sale altogether. These API protocols may include the ability to receive payment as a credit at the registrar level, obviating any need for the seller to establish contact with the registry directly on the successful outcome of a sale.

In the first disclosed embodiment, each participating registrar interfacing with the top-level domain registry creates and manages a registry account for each user seeking to sell a domain name. Since a user may have several different accounts across different registrars, a user may also have multiple accounts at the top-level domain registry.

In the second disclosed embodiment, the registry will maintain not only a thick Whois database, searchable by users and registrars via EPP but an extensive registry database, or Database Management Platform, that indicates whether the name is for sale or not and, if so, the current offer price of the name.

In a third disclosed embodiment, the extended registry database, or Database Management Platform, will be modifiable by users using an account with a username and password. Such users may have listed names for sale at one or more registrars using the disclosed method, but have not created an account at the registry. In this embodiment, a registry-level account is created when upon the user's request; the registry sends an email with a temporary password to the email address on file in the Database Management Platform, which is also the email address on file at the WhoIs. This temporary password will allow the creation of an account on the registry.

In the third disclosed embodiment, once a verified account with a username and password has been created as disclosed above, practitioners skilled in the art will easily recognize means of consolidating the account with other accounts previously set up at different registrars, providing each user with one, unified registry-level account. By means of this consolidation, all domain sales done at different registrars will automatically be consolidated into a single place. In another embodiment, users may elect to consolidate payment as well, with payments being disbursed by the registry directly to the seller, as opposed to passed back to the different registrars.

In the fourth disclosed embodiment, the top-level domain registry itself may offer certain domains for sale at a higher than average price, even though these domains have not previously been registered. This particular case corresponds to high value names such as “tech.blog” or “cars.blog” within a new top-level domain such as .blog. To the outside world, such names appear as names for sale with a listed price (higher than the base-price). The difference is that the registry, not a prior registrant, receives payment following a sale. We note that an alternative embodiment allows these names to be made public in the Whois, even though they are, strictly speaking not yet registered.

In a fifth embodiment, users searching the Whois directly would be able to transact with one or more affiliated registrars to either buy the domain or make an offer to the owner of the domain. Practitioners skilled in the art will recognize that there many ways to display a list of registrars to the user, either before or after the user has logged in to the user account.

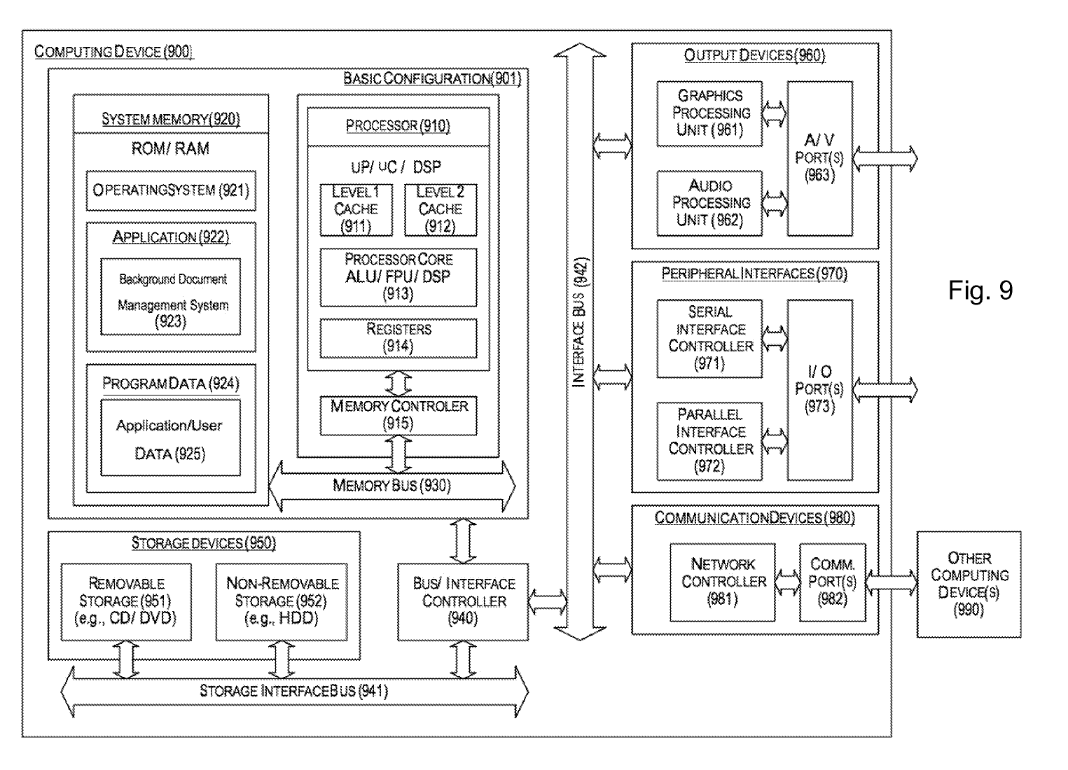

FIG. 9 is a block diagram illustrating an example computing device 900 that may be used to implement one or more embodiments of the software system, in accordance with the present disclosure. In a very basic configuration 901, computing device 900 typically includes one or more processors 910 and system memory 920. A memory bus 930 can be used for communicating between the processor 910 and the system memory 920.

Depending on the desired configuration, processor 910 can be of any type including but not limited to a microprocessor (μP), a microcontroller (μC), a digital signal processor (DSP), or any combination thereof. Processor 910 can include one more levels of caching, such as a level one cache 911 and a level two cache 912, a processor core 913, and registers 914. The processor core 913 can include an arithmetic logic unit (ALU), a floating point unit (FPU), a digital signal processing core (DSP Core), or any combination thereof. A memory controller 915 can also be used with the processor 910, or in some implementations the memory controller 915 can be an internal part of the processor 910.

Depending on the desired configuration, the system memory 920 can be of any type including but not limited to volatile memory (such as RAM), non-volatile memory (such as ROM, flash memory, etc.) or any combination thereof. System memory 920 typically includes an operating system 921, one or more applications 922, and program data 924. Application 922 may include background document management software system 923, in accordance with the present disclosure. Program Data 924 may include applicant or organizational data 925 that may be useful as has been further described above. In some embodiments, application 922 can be arranged to operate with program data 924 on an operating system 921 such that operation of a system may be facilitated on general purpose computers.

Computing device 900 can have additional features or functionality, and additional interfaces to facilitate communications between the basic configuration 901 and any required devices and interfaces. For example, a bus/interface controller 940 can be used to facilitate communications between the basic configuration 901 and one or more data storage devices 950 via a storage interface bus 941. The data storage devices 950 can be removable storage devices 951, non-removable storage devices 952, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 920, removable storage 951 and non-removable storage 952 are all examples of computer storage media. Computer storage media (or computer-readable medium) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media can be part of device 900.

Computing device 900 can also include an interface bus 942 for facilitating communication from various interface devices (e.g., output interfaces, peripheral interfaces, and communication interfaces) to the basic configuration 901 via the bus/interface controller 940. Example output devices 960 include a graphics processing unit 961 and an audio processing unit 962, which can be configured to communicate to various external devices such as a display or speakers via one or more A/V ports 963. Example peripheral interfaces 970 include a serial interface controller 971 or a parallel interface controller 972, which can be configured to communicate with external devices such as input devices (e.g., keyboard, mouse, pen, voice input device, touch input device, etc.) or other peripheral devices (e.g., printer, scanner, etc.) via one or more I/O ports 973. An example communication device 980 includes a network controller 981, which can be arranged to facilitate communications with one or more other computing devices 990 over a network communication via one or more communication ports 982. The communication link is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 900 can be implemented as a portion of a small-form factor portable (or mobile) computer such as a cell phone, a personal data assistant (PDA), a personal media player device, a wireless web-watch device, a personal headset device, an application specific device, or a hybrid device that include any of the above functions. Computing device 900 can also be implemented as a personal computer including both laptop computer and non-laptop computer configurations.

The invention is:

1. A computer system for registering and reselling domain names, comprising:
a central registry Database Management Platform maintaining a list of domain names for sale; an asking price for each domain name for sale; contact information about a seller for each domain name for sale; and a registrar where each domain name for sale is held.

2. The computer system recited in claim 1 further comprising a mechanism for connecting with different registrars, wherein the mechanism includes a sub-mechanism to create accounts on the central registry Database Management Platform; to update the sales prices of any domain name listed for sale; to receive credit on a successfully transacted sale; and to cancel any domain sales.

3. A method for listing domain names in an electronic marketplace, comprising:
creating a connection between a user account on a domain name registrar and a user account on a top-level domain registry using a user ID authorization process;
if a seller has selected a domain name to acquire, presenting the seller with an option to sell the domain name at a specific price; and
storing the domain name and the specific price in a top-level domain registry database.

4. The method recited in claim 3, further comprising:
providing a protocol for querying the top-level domain registry database for a specific name and returning whether that name is available at a previously determined price;
providing a protocol for changing the registration record for a specified string corresponding to a name that was offered for sale and crediting the user account that is linked to that name and debiting the registrar the amount of the sale price less any transfer fees; and
providing a protocol for changing the sale price of a domain name; and a protocol for removing a domain name from the list of names for sale.

5. The computer system recited in claim 1, further comprising a centralized web application maintained by the top-level domain registry database and independent of any registrar that allows users to maintain and view their account balances, change passwords, change the sale price for individual domain names or for selected domain names in bulk, and the ability to cancel the sale of a domain name completely; if a password has not been created yet at the registry level, the password can be created by sending an email to the email address on record at the Whois.

6. The method recited in claim 4, further comprising:
providing a protocol to list the domain name as “make offer” in addition to or instead of listing it as a fixed price;
providing a protocol to submit a specific offer to a domain name, if that particular domain name is listed as a “make offer” domain; and
providing a protocol to communicate that offer to the owner of the domain name, and either counter with a different counter-offer, or accept the offer.

7. The method recited in claim 6, where the counter-offer is not made public, but listed only to the person bidding on the name.

8. The method recited in claim 6, where the counter-offer is valid for a specific time only, wherein the specific time for which the counter-offer is valid, is set either at the centralized web application, or via an API protocol at the registrar.

9. The method recited in claim 6, where an initial deposit must be made in order to submit a counter-offer.

10. The computer system recited in claim 5, where users can combine multiple accounts.

11. The computer system recited in claim 5, where users can log in to an associated registrar and make an offer on any name in the centralized registry database repository.
